(19) United States
(12) Patent Application Publication
(10) Pub. No.: US 2018/0029870 A1
(43) Pub. Date: Feb. 1, 2018

(54) MOBILE CONTAINMENT AND DISTRIBUTION PADS

(71) Applicant: ENVIRONMENTAL REFUELLING SYSTEMS INC., Edmonton (CA)

(72) Inventors: Scott M VAN VLIET, Edmonton (CA); Sean HANNIGAN, Edmonton (CA); Charles BROUSSEAU, Edmonton (CA)

(21) Appl. No.: 15/662,867

(22) Filed: Jul. 28, 2017

(30) Foreign Application Priority Data
Jul. 29, 2016 (CA) 2937485

(51) Int. Cl. B67D 7/32; B60K 15/04

(52) U.S. Cl. CPC B67D 7/3209; B60K 15/04

(57) ABSTRACT

A containment pad with a basin and a porous cover is provided for supporting a vehicle. Service conduits are provided within the containment pad allowing fluid and/or electrical and instrumentation connections to be connected through the containment pad, allowing for example a fuel tank to connect to a dispenser through the containment pad allowing a gas station to use dispensing islands with no underground piping. A modular interlocking design allows multiple lanes and dispensing islands.

### CROSS-REFERENCE TO RELATED APPLICATIONS

This application claims priority of Canadian patent application serial no. 2,937,485 filed Jul. 29, 2016, which is incorporated by reference into this application in its entirety.

### TECHNICAL FIELD

Containment pads and fluid distribution apparatus.

### BACKGROUND

There is need for efficient, cost effective and environmentally safe solutions for the distribution of gasoline and diesel to customers in remote settings. Containment pads for supporting refueling vehicles and containing spills are known, see US patent application no. 2012/0074033. Separately, fuel dispensing apparatus are known, but it appears that currently available designs are connected to fuel tanks either by aboveground pipes that prevent vehicles from moving between the tank and the pump or by underground pipes that require ground disturbance to install with corresponding costs and environmental concerns.

### SUMMARY

A containment pad is provided comprising a basin for containing spilled fluids, a porous covering over the basin for supporting a vehicle, and a service conduit within the basin for providing an electrical, signaling or tubing connection through the basin.

In various embodiments, there can be included any one or more of the following features: the containment pad can be configured to be placed adjacent to a further containment pad. There can be an interlock to connect the containment pad to the further containment pad. The service conduit can be configured to connect to a further service conduit of the further containment pad through a service port in the containment pad and a further service port in the further containment pad. There can be a connector for connecting the service port to the further service port. The connector can comprise a boot type seal. The service port and further service port can be located in respective side walls of the containment pad and further containment pad, and the connector can provide a flow path for spilled fluids to flow between the containment pad and the further containment pad. The service conduit can comprise tubing to support a flow of fluid. The fluid can be a fuel. The service conduit can comprise an electrical wire for providing electricity. The service conduit can comprise a signal line for carrying a signal. The containment pad can comprise support beams for supporting the porous covering. The porous covering can comprise plural sections each connected to a respective support beam or to an upper periphery portion of the basin. There can be forklift receiving pockets extending into the basin. The containment pad can have a support element for supporting and orienting an object extending upward from the containment pad.

There is also provided a fluid distribution island comprising a basin, a fluid distribution unit supported above the basin, and tubing within the basin connected to the fluid distribution unit and configured to connect to tubing in a containment pad to connect the fluid dispenser to a fluid source via the containment pad.

There is further provided a fluid distribution facility kit comprising a containment pad having a basin for containing spilled fluids, a porous covering over the basin for supporting a vehicle, and a service conduit within the basin for providing a tubing connection through the basin to support a flow of fluid; a fluid storage tank configured to connect to the containment pad to supply fuel to the tubing; and a fluid distribution island configured to connect to the containment pad to receive fuel from the tubing.

There is also provided a fluid distribution system comprising one or more fluid sources, at least one fluid distribution unit, and plural containment pads, the plural containment pads placed contiguously to each other, each containment pad forming at least a basin, each fluid distribution unit being associated with and supported by a containment pad of the plural containment pads, and each fluid distribution unit being connected to a fluid source of the one or more fluid sources to receive fluid.

In various embodiments, there can be included any one or more of the following features: there can be interlocks to connect the containment pads to each other. There can be service conduits, each service conduit passing through a respective basin and each service conduit connecting to a respective fluid distribution unit. The service conduits can pass from containment pad to containment pad via adjacent service ports in the respective containment pads. Adjacent service ports have a sealed connection for reducing spill risk. In some embodiments, each service conduit can comprise tubing for supplying fluid. Each service conduit can comprise an electrical wire for providing electricity. Each service conduit can comprise a signal line for carrying a signal. There can be respective porous coverings over each basin and respective support beams in each basin for supporting the porous covering. There can be for each containment pad, forklift receiving pockets extending into the basin. The containment pads can be organized to define lanes. In some embodiments, the service conduits can cross the lanes. The containment pads can comprise support slots for supporting and orienting objects extending upward from the containment pads. The fluid can be a fuel.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a perspective view of simplified exterior structure of an embodiment of a containment mat;

FIG. 2 is a perspective view of the embodiment of FIG. 1 showing interior structure;

FIG. 3 is a closeup of the view of FIG. 2;

FIG. 4 is a closeup perspective view of an embodiment of a boot type seal;

FIG. 5 is a schematic side view of two containment mats showing an interface between the containment mats;

FIG. 6 is a schematic end view of a fuel station showing multiple lanes with fuel transfer to island dispensers between the lanes through containment mats;

FIG. 7 is a schematic top view of a fuel station or fuel dispensing system with multiple contiguous containment pads with fuel dispensing islands;

FIG. 8 is a partial top view of an embodiment of a containment mat and a dispensing island, with gratings, crash barriers and dispensers removed to better show internal components;

FIGS. 9A-9E are respectively a side cutaway view of the elements of a containment mat shown in FIG. 8, from view line 9A shown in FIG. 8, an end view of the elements of a containment mat shown in FIG. 8, from view line 9B shown in FIG. 8, an end cutaway view of the elements of a containment mat shown in FIG. 8, from view line 9C shown in FIG. 8, a cutaway view of the elements of a dispensing island shown in FIG. 8, from view line 9D shown in FIG. 8, and a cutaway view of the elements of a dispensing island shown in FIG. 8, from view line 9E shown in FIG. 8;

FIG. 10 is a partial top view of an embodiment of a containment mat and a dispensing island, with crash barriers and dispensers shown but gratings and support elements removed;

FIGS. 11A-11E are respectively a side cutaway view of the elements of a containment mat shown in FIG. 10, from view line 11A shown in FIG. 10, an end view of the elements of a containment mat shown in FIG. 10, from view line 11B shown in FIG. 10, and an end cutaway view of the elements of a containment mat shown in FIG. 10, from view line 11C shown in FIG. 10, a cutaway view of the elements of a dispensing island shown in FIG. 10, from view line 11D, and a cutaway view of the elements of a dispensing island shown in FIG. 10, from view line 11E;

### DETAILED DESCRIPTION

In this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

For the purposes of this specification, and the claims set out herein, the term “fuel” shall be interpreted to mean any one of the following: gasoline, diesel fuel, propane, liquid natural gas, oil, grease, lubricants, petrochemicals, liquid chemicals, liquid additives and gases, any of which that can be intended for industrial, commercial or consumer consumption or use.

A drive-on containment pad is provided including piping to connect a fuel dispensing island to a fuel tank. This integration of drive-on containment pads and fuel dispensing islands was created to safely and cost-effectively expand the fuel dispensing capability of dispensers, e.g. cardlock tanks, in remote areas. In some embodiments, this system can be fully self-contained, above ground, manage environmental risk of refueling heavy and light vehicle equipment, and provide a safe and economically viable solution to typically high cost cardlock island setups. The same system can be used to distribute of other fluids than fuel. For example, distribution of water for use, for example, in a wash bay, or distribution of compressed air. The system can also be used to distribute fluids in a reverse sense, i.e. providing a vacuum to collect air or other fluids and possibly entrained materials. The primary embodiments will be discussed in relation to distribution of fuel but it should be understood that the claimed invention will apply also to distribution of other fluids, with appropriate replacement of a fuel dispenser with another fluid distribution unit (which may include, for example, a pressure-retaining nozzle in a wash bay, or a vacuum hose in a vacuum embodiment) and of the fuel tank with another fluid source. In view of the fact that a vacuum is possible, “fluid source” here and in the claims is used to include a vacuum source, to which fluid is drawn.

In an embodiment, the drive-on containment pads are modular, mobile, heavy duty, interlocking grated systems that capture any environmental contaminants spilled during refueling operations in the field. In an embodiment, the modular containment pads are rectangular units connectable by width and length while continuing piping between the containment pads. In conjunction with fuel dispensing islands they become a unique system that provides flexibility for high demand operations or locations where petroleum distribution is essential. In an embodiment, there is provided a modular integrated system that does not require ground disturbance of any kind.

In some embodiments, an integrated fueling system can combine a fuel storage and dispensing tank with the containment pads, quick connect fuel piping, legal-for-trade cardlock dispensers and built in area lighting. The complete system allows petroleum products to be stored, transferred from the fuel tank, safely mobilized in piping contained within the pads and supplied to the legal-for-trade fuel dispensers located between containment pads.

In an embodiment, the containment pads can comprise a steel structure designed to contain liquids without allowing anything to escape to the ground. Their heavy duty design allows industrial equipment to drive over the grated top and stop next to the fuel nozzle. A cardlock system activated by the customer engages the pump in the tank which pressurizes the lines contained in the pads which then delivering fuel to the dispensing islands. Equipment can be fueled up safely, quickly and efficiently.

Environmental protection features that can be provided by embodiments of the systems disclosed here include: mitigation of environmental risk of refueling vehicles, or other forms of fluid transfer, by preventing spills from touching the ground; containment of, in an exemplary embodiment, 800 liters of liquid per pad (although the volume of liquid can vary as a function of the physical dimensions of the containment pad); contents of containment pads are contained and visible by overhead observation; no ground disturbance requirement as all components can be above ground; piping is contained with visual leak detection, or in other embodiments electronic or mechanical leak detection, or a combination of visual with electronic or mechanical leak detection; minimized footprint at site with multiple user capacity; easy clean-up of fluid and contaminants; reduced tank requirements with multiple island dispensing capacity; fuelling pad stability reduces continuous ground repair for level fuelling needs (ground does not need to be graded at dispensing point as a result of vehicle traffic);

Safety protection features that can be provided by embodiments of the systems disclosed here include: traffic patterns on high volume industrial or project sites are separated by multiple islands; Gasoline and Diesel mixes are reduced due to multiple islands; Separation of heavy and light vehicle traffic; Managed traffic flow to reduced Risk of collision; Increased traffic control; Anti-slip grating benefits vehicle and pedestrian traffic; Hinged grating allows for easy access to distribution plumbing, communication and electrical systems; High Visibility; All piping and connections contained in the pads but are visible and accessible; Damages are visible and accessible so they can be noticed and repaired immediately; All piping is painted to meet NFC regulations; may replace multiple fuelling stations from larger project sites for a smaller overall distribution foot print; Area lighting keeps the distribution system a high visibility region; Remote card readers on each island reduces pedestrian traffic amongst equipment.

In some embodiments, the containment pads can be of a heavy duty design, e.g. comprising steel, for drive on capability. The containment pads can each comprise one or more basins for collecting contaminants and one or more gratings for supporting vehicles while allowing contaminants to fall through the grating into the basin(s). The grating can also allow for visibility and protection of plumbing and other service lines. The grating can also provide an anti-slip surface for safety. The grating can be hinged for easy access, or alternatively surface panels can be provided to allow access. The containment pads can be constructed from modular interlocking sections place side by side to allow for easy expansion so that together the containment pads are contiguous and form a single island.

In some embodiments, the containment pads and other items can be fully above ground to allow set-up and removal with no ground disturbance. An interlock design can be used for stability and can also help provide a level environment for pedestrians, and connectivity of plumbing and electrical connections. Plumbing connections can be provided with flexible tubing to allow small ground movements. Multiple sets of pipes can be provided, allowing for distribution of multiple products. The design allows for the easy addition or deletion of product plumbing, electrical and communication wiring. Cable trays can be provided with perforated bottoms for the release of moisture and contaminants into the containment pad. Plumbing can be made of durable steel components and industrial railway connections to protect against leakage yet allow ease of disconnection for mobility. Drain ports can be provided for controlled fluid release and filtration of hydrocarbon contaminants. Pads are designed for the acceptance of protective posts or fencing.

In some embodiments, the dispensing islands can also use a modular design for simple dispensing island expansion with containment pad expansion. This allows for various geometric patterns for the available site foot print. The dispensing islands can be interlocking to containment pads. The dispensing islands can have an anti-slip surface for pedestrians. Crash protection can be provided on each side to protect dispensing and reader equipment from accidental collision. Hinged gratings or surface panels can be provided to allow easy access to dispensing equipment, cleaning, electrical and plumbing, while keeping the piping protected under a surface layer. Flexible piping allows for ease of connection from containment pads to dispensing equipment and allows for some ground movement. In some embodiments, flexible electrical cables can allow for ease of connection form containment pads to dispensers and island cardlock readers. Flexible design allows for multiple products to be distributed from each dispensing island. Flexible plumbing design allows for multiple product distribution. The flexible design allows for the easy addition or deletion of product plumbing, electrical and communication wiring. Cable trays can have perforated bottoms for the release of moisture and contaminants into the containment pad. Plumbing can be made of durable steel components, industrial railway connections and robust plumbing, hose and pipe fittings, as well known to those skilled in the art, to protect against leakage yet allow ease of disconnection for mobility. Drain ports can be provided for control fluid release and filtration of hydrocarbon contaminants. Pads are designed for the acceptance of protective posts or fencing. Telescopic or otherwise collapsible, e.g. foldable, light standards can be provided for high visibility and safety.

In some embodiments, the fluid levels in the containment pad can be monitored and controlled, e.g. by sucking out spilled fluids using a vacuum, as a matter of routine maintenance. Optionally, a tent or other roof structure can be provided to prevent precipitation from collecting in the containment pads in order to reduce the burden of collecting additional fluid volume.

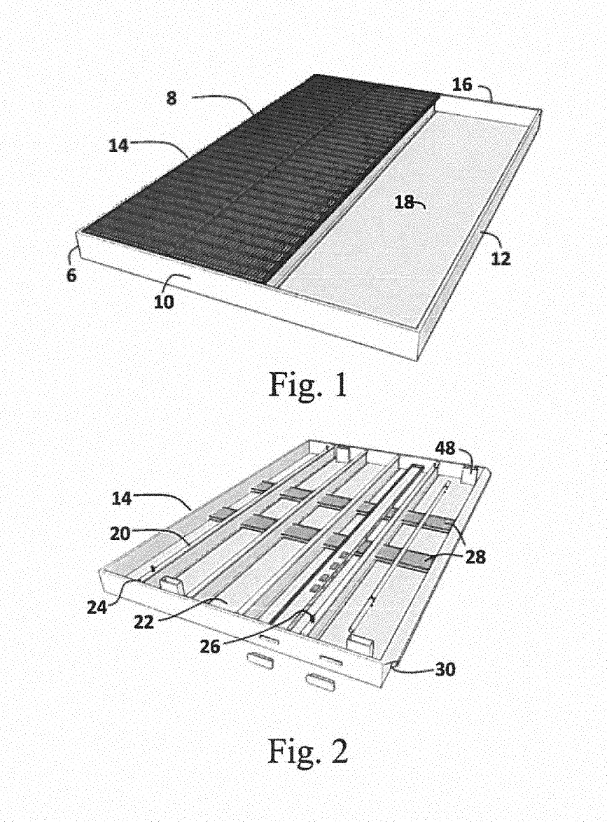

FIG. 1 shows a view of the outer structure of an embodiment of a containment pad. As shown in FIG. 1, a containment pad can comprise a pan element 6 and a collection of grating elements 8 associated with the pan element. The pan element in the embodiment shown comprises two pairs of opposing sides 10, 16 and 12, 14 perpendicularly attached to bottom 18, making a rectangular pan element, but other shapes are possible. In the embodiment shown the dimensions of the bottom are 7′ 8″ wide by 12 feet long, and the walls 10 inches high.

FIG. 2 shows a view of the internal structure of the embodiment of FIG. 1. In this embodiment parallel beams 20 extend between the side walls of each pan, defining sub-sections 22 of the pan between adjacent beams. Openings (not shown), for example at the ends of the beams, permit spilled fluids to flow between sub-sections within a single pan to a drain or vacuum hose opening for removal. In a preferred embodiment, the openings are formed adjacent to the bottom of the pan by cutting the bottoms of the beams at an angle. In the embodiment shown, lifting hooks 26 are connected to various points of beams 20, through openings in the gratings to enable the system to be easily installed and removed. The embodiment shown also has parallel, hollow and rectangular beams 28 installed along the bottom 18 perpendicular to beams 20. These hollow beams 28 are fastened to the side walls 14 and 12 to form openings to enable a forklift to lift and position the mat, thereby saving time and effort. These features can be used together as shown in FIG. 2 or independently.

Gratings 8 overlay the pan 6 to provide support for the vehicle or equipment to be serviced. In the embodiment of FIGS. 1-4 the grating is 2 inches thick.

In a preferred embodiment, each grating is attached to one of beams 20 with a hinge (not shown in FIGS. 1-4). This enables the grate to be easily tilted up for cleaning the pan. In another preferred embodiment, handles (not shown in FIGS. 1-4) are embedded in the gratings 8 to make lifting them easier.

The grating covering the pan preferably has a serrated top surface to reduce the slip hazard to operators walking on the surface of the grating. The gratings 8 preferably cover substantially the entire surface of the pan to capture a spill anywhere within the area covered by the service support mat.

In operation, the size of the service support system can be determined for each job. The service support system comprises a plurality of connectable mats, each with grating elements. Each mat can, for example, be 7′8″ wide by 12 feet long, as shown in FIGS. 1-4. Individual mats can be connected to other pads to form service support systems of a desired length and width. For example, a service support system can be assembled which has a length of any multiple of 7′8″ for the embodiment shown in FIGS. 1-4. This flexibility permits tailoring the length requirements of the service support system to each particular job.

Each pan of the service support mat shown in FIGS. 1-4 includes a latching mechanism 30 for interconnection of the ends or sides of the individual pans. The latching mechanism in this embodiment is formed by extending the top of the sides 14 or 12 and bending it into a lip which can slide over the adjacent mat side and fall into place to secure the mats together as well as reducing spills between the mats.

The system can support several kinds of services including fuel, lubrication, water, air, other fluids as well as electrical and instrumentation (E&I).

In the embodiment shown in FIGS. 1-4, fluid based services (such as fuel) are carried inside the pan by rigid piping 32 attached to supports 34 which are welded to the pan bottom 18. The rigid pipe is connected in this embodiment to pipes in adjacent mats by flexible connectors (not shown) through fluid service ports 36 cut into a side wall. In other embodiments, other forms of tubing (e.g. flexible hoses) and different connections could be used. The term “fluid service port” does not exclude other services than fluids going through the port.

For the purposes of this document the term “service conduit” can include any conduit for providing one or more services, including, e.g., a line, wire or tubing element for providing a service and associated support or containing elements, and can include multiple service conduits connected in series, or to multiple service conduits arranged generally in parallel, e.g. extending between the same side walls of a containment pad shaped to have side walls, or traversing the same sequence of containment pads.

Electrical and Instrumentation (E&I) and other non-liquid services can be carried in one or more non-liquid service conduits 38. In the embodiment shown they communicate with a similar service conduit in adjacent mats through E&I service ports 40 cut into a side wall 14 or 16. In an embodiment, the bottom of the E&I service conduit 38 is perforated or notched, here shown with perforations 42, to enable liquid drainage and air circulation. E&I services can include electrical wire for providing electricity, and electrical or non-electrical signal carrying lines. The services can connect to, for example, fluid distribution units or other equipment such as lights.

In an embodiment, each pan includes one or more drains (not shown) set into the side wall or end wall of the pan. Locating the one or more drains on the pan wall decreases the likelihood of blockage or damage of the drain as compared to a drain positioned on the bottom of a pan. The wall position of the drain furthermore permits collection of the fluids for transport to another location, or addition of water filtration and other fluid treatment processing of the spilled fluids, without the need to raise the pan or install piping under the pan.

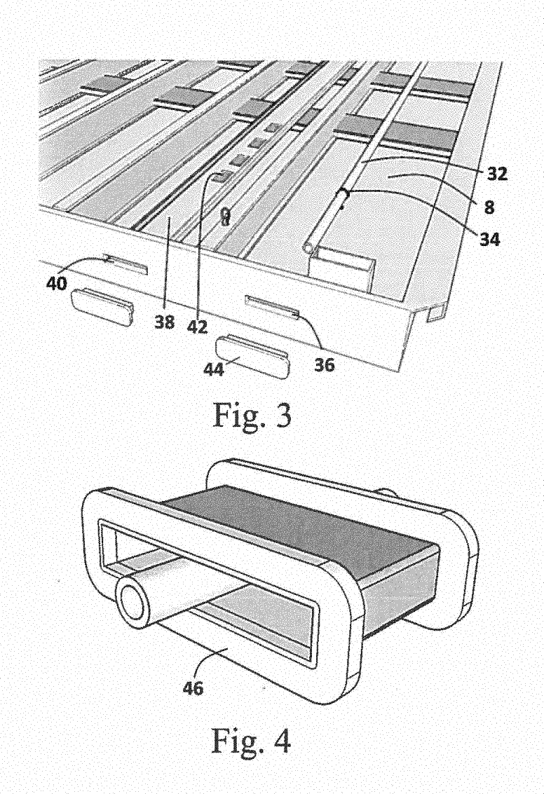

In one embodiment, the fluid service port 36 is sealed to prevent captured liquids escaping by a plate type port seal 44. In another embodiment, the fluid service port 36 is connected to the fluid service port of the adjacent mat by a boot-type port seal 46 to allow captured liquids to equalize into multiple mats, maximizing the effective capacity of the system for a single spill. FIGS. 1-4 show in FIG. 3 a plate type port seal 44 for use when a connection through the port to an adjacent mat or other spill capturing unit is not required, and in FIG. 4 a boot type seal 46 for use when the mat is connected to an adjacent mat or other spill capturing unit, and it is desired to connect the fluid piping 32 to further piping in the adjacent unit. In the illustrated embodiments, service port 36 is shown having a rectangular cross-section opening, with port seal 44 and boot seal 46 similarly shaped with a rectangular cross-section to fit in or through service port 36, respectively. It is well known to those skilled in the art that service port 36, and its corresponding port seal 44 and boot seal 46, can comprise any cross-section shape that can include, without limitation, circular, oval or elliptical, square, polygonal and irregular shapes all the while maintaining the same functionality.

The E&I service ports 40 can be sealed in similar manners to the fluid service ports 36. The E&I service ports and fluid service ports can also be combined into ports connecting both fluid and non-fluid services. In the illustrated embodiment, service port 40 is shown having a rectangular cross-section opening although service port 40 can comprise any cross-section shape that can include, without limitation, circular, oval or elliptical, square, polygonal and irregular shapes, as well known to those skilled all the while maintaining the same functionality.

Heat tubes can be passed through the fluid service ports 36. Heating mechanisms can also pass through a non-fluid service port. When heated to above 0 C any captured fluids are liquefied and easily removed by vacuum or other means.

There can also be supporting elements 48 for supporting and orienting objects extending from the supporting elements. In the embodiment of FIGS. 1-4 the supporting elements 48 comprise vertical support slots attached to the pan bottom and side wall, into which a supported object can be fitted. These supporting elements can support for example crash barriers, guide posts, light poles or free standing walls. Free standing walls are not typical for gas station embodiments but can be useful for example to form a wash bay in a wash embodiment.

In alternate embodiments, the containment mat can be triangular, hexagonal, or any other selected geometry which will permit modular assembly to form a larger containment mat. The containment mats could even have irregular shapes as long as the shapes of adjacent mats complement each other.

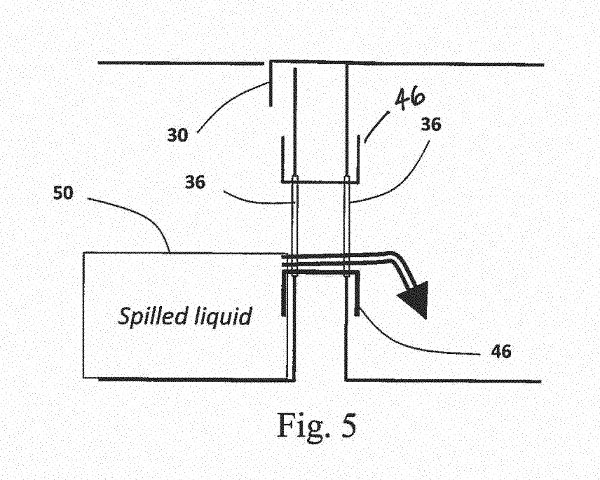

FIG. 5 is a schematic side view of two containment mats showing an interface between the containment mats. Latching mechanism 30 as shown comprises an extension of a top portion of a basin of one containment mat formed into a lip extending into a basin of another containment mat to connect the containment mats. A boot type seal 46 is shown connecting between two adjacent fluid service ports 36 (service conduits not shown in FIG. 5). Spilled liquid 50, on reaching a level corresponding to the service ports 36, overflows from one containment mat to the other via the boot seal 46.

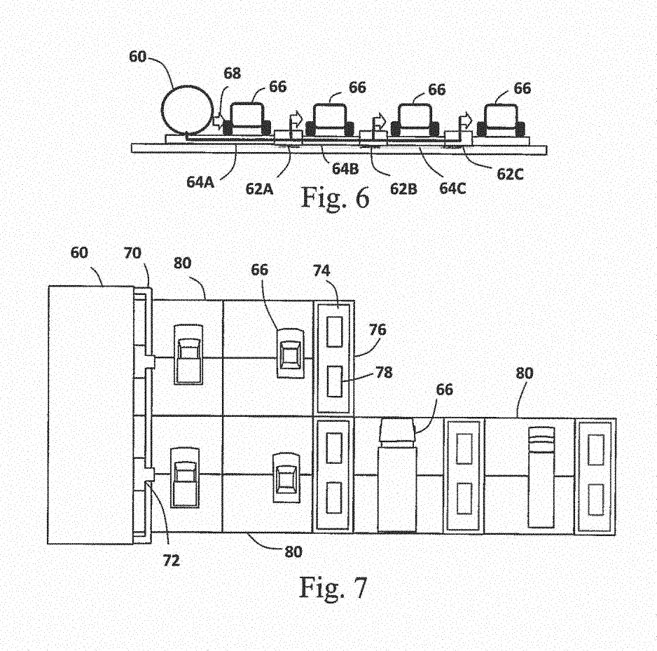

FIG. 6 is a schematic end view of a fuel station showing multiple lanes with fuel transfer to island dispensers between the lanes through containment mats. A fuel tank 60 supplies fuel to a fuel dispenser on dispensing island 62A via containment mat 64A. Fuel lines can extend from fuel tank 60 through dispensing island 62A to further fuel dispensing islands 62B and 62C via further containment mats 64B and 64C to allow fueling of vehicles 66 in many lanes at once. There can also be fuel dispensers adjacent to the fuel tank 60 to enable fueling of vehicles adjacent to the fuel tank 60 (as shown schematically by fuel-flow indication arrow 68).

FIG. 7 is a schematic top view of a fuel station. A fuel tank 60 is shown with an attached crash barrier 70 and fuel dispensing units 72. Dispensing islands 74 comprise crash barriers 76 and island fuel dispensing units 78. Containment mats 80 are aligned in the embodiment shown so that the lengths of the mats form the widths of lanes, with multiple mats arranged side by side to form longer lanes and end to end to form wider lanes. The fuel tank 60 can have multiple compartments, for example a gasoline compartment and a diesel compartment to supply fuel to both gasoline and diesel dispensers. In an embodiment, the pumps for all dispensers are located at the fuel tank 60. The arrangements of lanes and dispensers is adjustable by placing the containment mats, dispensing islands and the fuel supply tubing extending through the containment mats and dispensing islands in different configurations.

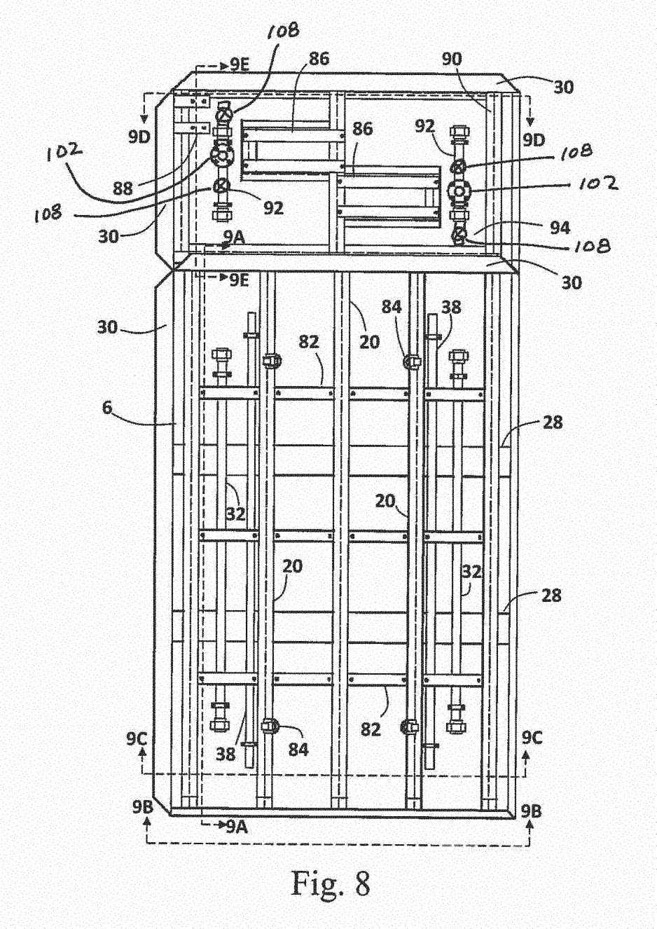

FIG. 8 is a partial top view of an embodiment of a containment mat and a dispensing island, with gratings, crash barriers and dispensers removed to better show internal components. In the embodiment shown there are support beams parallel to both the length and width of the containment mat, parallel beams 20 supporting additional support beams 82 arranged perpendicular to the parallel beams 20. In this embodiment, hinges (not shown) for rotatably connecting gratings (not shown) are attached to the additional support beams 82. The gratings can also be movably connected to the containment pad in other manners such as by being removable by lifting the grating out to access the area under the grating. They can also be fixed.

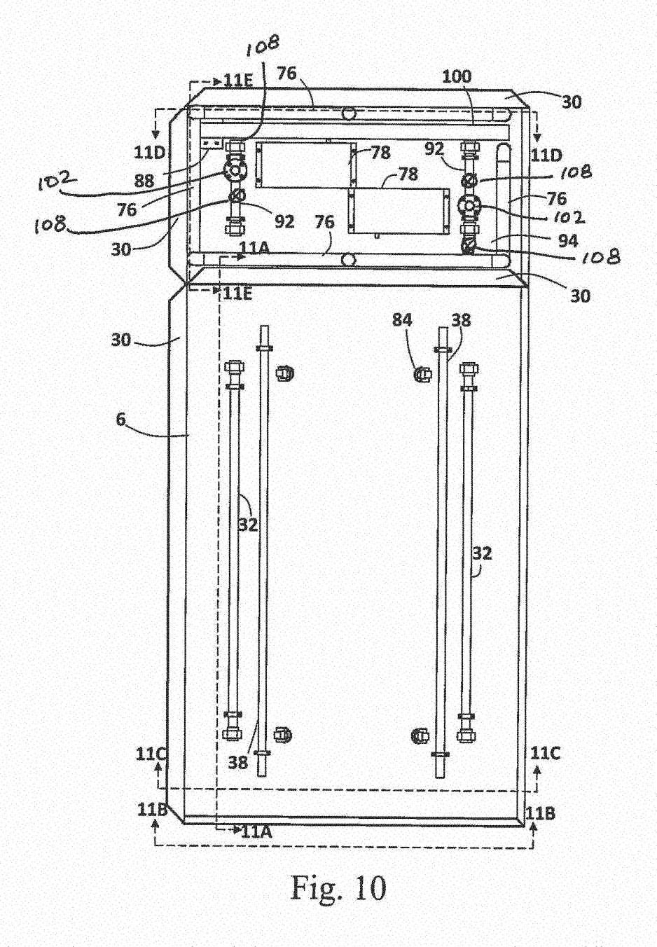

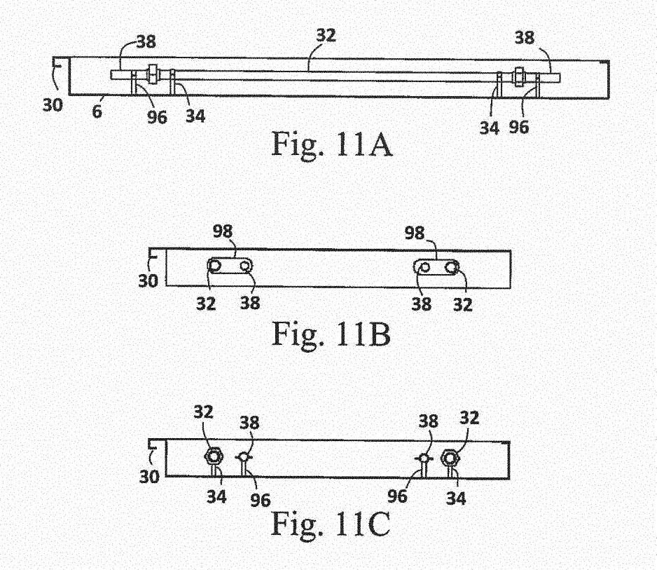

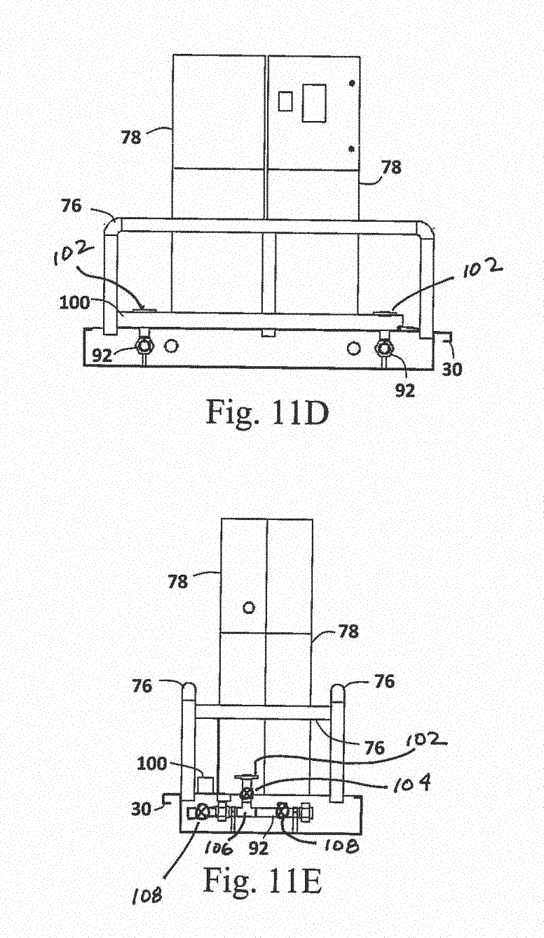

In this embodiment, non-liquid service conduit 38 comprises tubing. Forklift receiving pockets are provided by hollow beams 28. Lifting lugs 84 are provided on the parallel beams 20 to enable suspension of the containment mat from the lifting lugs to place or remove the containment mat. The dispensing island shown has two dispensers (not shown in this view for clarity, but shown in FIGS. 10 and 11D-11E). Dispenser support beams 86 support the dispensers. The dispensing island also has light post supporting elements 88 and crash barrier supporting elements 90. Piping assemblies 92 within the dispensing island can be connected to fluid service conduits 32 within the containment mat to supply fuel to the dispensing islands. Piping assemblies 92 connect to the dispensers and can also be connected to further containment mats to supply fuel to further dispensing islands. In some embodiments, one or more piping assembly 92 can further comprise connection flange 102 to enable coupling to the dispensers, wherein flange 102 can be coupled to isolation valve 104 prior to coupling to tee 106 having two ports exiting therefrom, as shown in FIGS. 8, 9E, 10, 11D and 11E. In some embodiments, each exit port of tee 106 can further couple to an isolation valve 108. The inclusion isolation valves 104 and 108 can enable the ability to move from an open position and a closed position, thereby enabling the ability to control fluid flow through or in any given piping assembly 92, and to control which direction fluid can flow through piping assemblies 92. In some embodiments, one or both of isolation valves 104 and 108 can comprise manually-controlled stainless steel ball valves, as well known to those skilled in the art. In other embodiments, one or both of isolation valves 104 and 108 can comprise one or more of electronically-controlled, solenoid-controlled, pneumatically-controlled and hydraulically-controlled valves, as well known to those skilled in the art, wherein the isolation valves can be controlled by a computer-based controller or programmable logic controller (not shown), as well known to those skilled in the art.

In some embodiments, the dispensing island shown has a basin 94 above which the dispensing units are supported and gratings (not shown) to accept spilled fluid into the basin 94. Latching mechanisms 30 are present on the dispensing island as well as the containment mat allowing the dispensing island to connect to other dispensing islands and further containment mats.

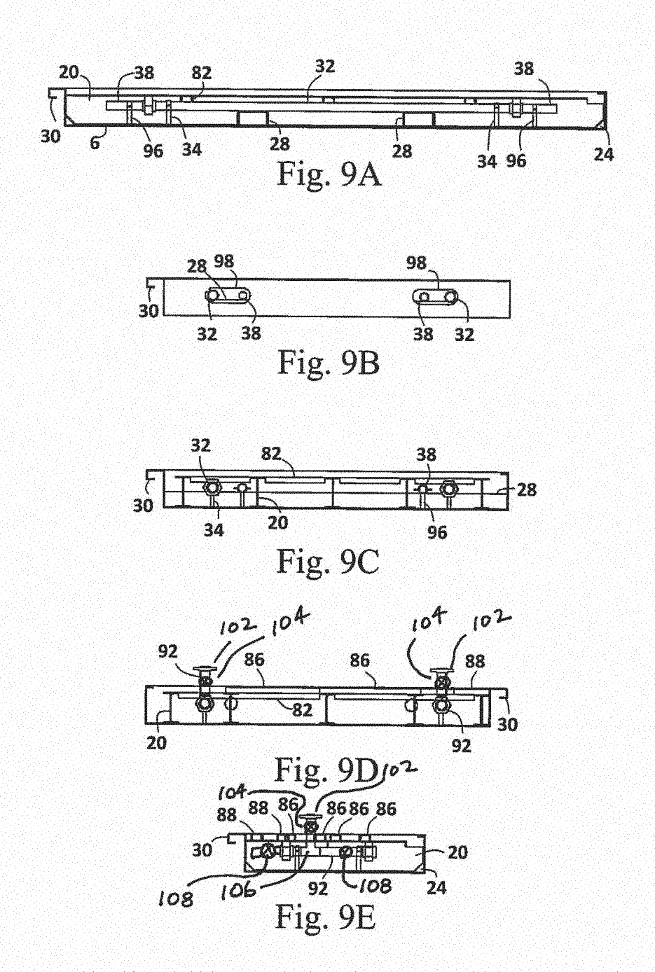

Additional views of the containment mat of FIG. 8 are shown in FIGS. 9A-9C, and additional views of the dispensing island of FIG. 8 are shown in FIGS. 9D and 9E. The same elements omitted from FIG. 8 are also omitted from FIGS. 9A-9E. FIG. 9A is a side cutaway view as seen from view line 9A in FIG. 8. Supports for the liquid service conduit are indicated by reference numeral 34 and supports for the non-liquid service conduit are indicated by reference numeral 96. FIG. 9B is an end view as seen from view line 9B in FIG. 8. Service ports 98 act in this embodiment both as fluid service ports for containing tubing connected to piping 32 and as E&I service ports for containing tubing or wiring connected to or extended through non liquid service conduits 38. FIG. 9C is an end cutaway view as seen from view line 9C in FIG. 8. FIG. 9D is a cutaway view of the elements of a dispensing island shown in FIG. 8, as seen from view line 9D shown in FIG. 8. This embodiment of a dispensing island includes parallel beams 20 and additional support beams 82 analogous to their counterparts in the containment mat, as shown in FIG. 9D. FIG. 9E is a cutaway view of the elements of a dispensing island shown in FIG. 8, as seen from view line 9E shown in FIG. 8.

FIG. 10 and FIGS. 11A-11E show the same embodiment of a containment mat and dispensing island as FIG. 8 and FIGS. 9A-9E, but with different elements omitted. In these figures the crash barriers and dispensers that were omitted in FIG. 8 are included, but the support elements that were shown in FIG. 8 are omitted. Gratings are omitted in both sets of figures. FIG. 10 is a partial top view of this embodiment of a containment mat and a dispensing island. Dispensers are indicated with reference numeral 78 and crash barriers with reference numeral 76. In this embodiment, the crash barriers 76 protect all sides of the dispensing island, with a gap for light post 100 which is shown in a horizontal orientation but movable between horizontal and vertical orientation.

Additional views of the containment mat of FIG. 10 are shown in FIGS. 11A-11C, and additional views of the dispensing island of FIG. 10 are shown in FIGS. 10D and 10E. The same elements omitted from FIG. 10 are also omitted from FIGS. 10A-10E. FIGS. 11A-11C are respectively a side cutaway view of the elements of a containment mat shown in FIG. 10, as seen from view line 11A, an end view of the elements of a containment mat shown in FIG. 10, as seen from view line 11B, an end cutaway view of the elements of a containment mat shown in FIG. 10, from view line 11C, a cutaway view of the elements of a dispensing island shown in FIG. 10, as see from view line 11D, and a cutaway view of the elements of a dispensing island shown in FIG. 10, as seen from view line 11E.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A containment pad, comprising:
a basin for containing spilled fluids;
a porous covering over the basin for supporting a vehicle; and
a service conduit within the basin for providing an electrical, signaling or tubing connection through the basin.

2. The containment pad of claim 1, wherein the containment pad is configured to be placed adjacent to a further containment pad.

3. The containment pad of claim 2, further comprising an interlock to connect the containment pad to the further containment pad.

4. The containment pad of claim 2, wherein the service conduit is configured to connect to a further service conduit of the further containment pad through a service port in the containment pad and a further service port in the further containment pad.

5. The containment pad of claim 4, further comprising a connector for connecting the service port to the further service port.

6. The containment pad of claim 5, wherein the connector comprises a boot type seal.

7. The containment pad of claim 5, wherein the service port and the further service port are located in respective side walls of the containment pad and the further containment pad, and the connector provides a flow path for spilled fluids to flow between the containment pad and the further containment pad.

8. The containment pad of claim 1, wherein the service conduit comprises one or more of a group comprising of tubing to support a flow of fluid, an electrical wire for providing electricity and a signal line for carrying a signal.

9. The containment pad of claim 8, wherein the fluid is a fuel.

10. The containment pad of claim 8, wherein the tubing comprises at least one isolation valve, the at least one isolation valve configured to move between an open position and a closed position to control the flow of fluid therethrough.

11. The containment pad of claim 1, further comprising support beams for supporting the porous covering.

12. The containment pad of claim 11, wherein the porous covering comprises plural sections each connected to a respective support beam or to an upper periphery portion of the basin.

13. The containment pad of claim 1, further comprising forklift receiving pockets extending into the basin.

14. The containment pad of claim 1, further comprising a support element for supporting and orienting an object extending upward from the containment pad.

15. A fluid distribution island, comprising:
a basin;
a fluid distribution unit supported above the basin; and
tubing within the basin connected to the fluid distribution unit and configured to connect to tubing in a containment pad to connect the fluid distribution unit to a fluid source via the containment pad.

16. The fluid distribution island of claim 15, wherein the tubing further comprises at least one isolation valve, the at least one isolation valve configured to move between an open position and a closed position to control a flow of fluid therethrough.

17. A fluid distribution facility kit, comprising:
a containment pad as claimed in claim 9;
a fluid storage tank configured to connect to the containment pad to supply fluid to tubing disposed therein; and
a fluid distribution island configured to connect to the containment pad to receive fluid from the tubing.

18. The fluid distribution facility kit of claim 17, wherein the tubing further comprises at least one isolation valve, the at least one isolation valve configured to move between an open position and a closed position to control a flow of fluid therethrough.

19. A fluid distribution system comprising one or more fluid sources, at least one fluid distribution unit, and plural containment pads, the plural containment pads placed contiguously to each other, each containment pad forming at least a basin, each fluid distribution unit being associated with and supported by a containment pad of the plural containment pads, and each fluid distribution unit being connected to a fuel source of the one or more fuel sources to receive fuel.

20. The fuel distribution system of claim 19, further comprising interlocks to connect the containment pads to each other.

21. The fuel distribution system of claim 19, further comprising service conduits, each service conduit passing through a respective basin and each service conduit connecting to a respective fluid distribution unit.

22. The fluid distribution system of claim 21, wherein which the service conduits pass from containment pad to containment pad via adjacent service ports in the respective containment pads.

23. The fluid distribution system of claim 22, wherein the adjacent service ports have a sealed connection for reducing spill risk.

24. The fluid distribution system of claim 21, wherein each service conduit comprises one or more of a group comprising tubing for supplying fuel, an electrical wire for providing electricity and a signal line for carrying a signal.

25. The fluid distribution system of claim 24, wherein the tubing further comprises at least one isolation valve, the at least one isolation valve configured to move between an open position and a closed position to control a flow of fluid therethrough.

26. The fluid distribution system of claim 19, further comprising respective porous coverings over each basin and respective support beams in each basin for supporting the porous covering.

27. The fluid distribution system of claim 19, further comprising, for each containment pad, forklift receiving pockets extending into the basin.

28. The fluid distribution system of claim 19, wherein the containment pads are organized to define lanes.

29. The fluid distribution system of claim 28, further comprising service conduits, each service conduit passing through a respective basin and each service conduit connecting to a respective fluid distribution unit, wherein the service conduits cross the lanes.

30. The fluid distribution system of claim 19, wherein the containment pads comprise support slots for supporting and orienting objects extending upward from the containment pads.

31. The fluid distribution system of claim 19, wherein the fluid is a fuel.
